(19) United States
(12) Patent Application Publication
(10) Pub. No.: US 2005/0171791 A1
(43) Pub. Date: Aug. 4, 2005

(54) Methods and systems to enhance a shipping transaction

(76) Inventors: Danette Chimenti, Austin, TX (US); Ruben Gamboa, Jelm, WY (US)

Correspondence Address: PERMAN & GREEN, 425 POST ROAD, FAIRFIELD, CT, 06824, US

(21) Appl. No.: 10/768,817

(22) Filed: Jan. 30, 2004

(51) Int. Cl. G06F 17/60

(52) U.S. Cl. 705/1; 705/39

(57) ABSTRACT

A system to enhance shipping transactions. The system includes a shipping server to store data, wherein the data comprises rates associated with a shipping transaction for more than one carrier; and instructions to install on a consumer device, to cause the consumer device to perform operations, comprising gathering data associated with a shipping transaction, in response to communication with a consumer, via a consumer device, from the shipping server when the shipping server is accessible and from a carrier server when the shipping server is inaccessible; generating a shipping label for the shipping transaction based upon the data; and recording the shipping transaction.

### BACKGROUND OF THE INVENTION

1. Field of the Invention

The present invention is in the field of shipping transactions and more particularly, methods and systems to gather data for a shipping transaction to ship a package via a carrier.

2. Brief Description of Related Developments

Many regular or repeat consumers of shipping services such as manufacturers, wholesalers, retailers, and individuals maintain an inventory of products to sell to customers. Carriers, such as the United States Postal Service (USPS), United Parcel Service (UPS), Federal Express (FedEx), DHL Airways (DHL), and the like, facilitate sales by transporting a product from the consumer's storage facility, or pickup location, to the customer, or drop-off location. However, the number of carriers, shipping methods offered by carriers, and costs involved with effective management of carriers, each having a complex set of rules and rates, makes it economically infeasible for the consumers to manage several carriers and shipping methods.

The advent of the Internet and other wide area networks (WANs) significantly changed the interface between consumers and carriers. Now consumers use consumer devices such as personal digital assistants (PDA's), desktops, laptops, and servers to access information about shipping transactions in relatively short periods of time. However, consumers must access each carrier's server separately to obtain rates and shipping options, repeatedly enter data about their customers or compromise security of their customer lists by storing them on Internet-accessible servers of more than one carrier, manually compare the rates and options of the different carriers for each shipping transaction, and wait for a carrier server to be available to print a shipping label for the carrier.

### SUMMARY OF THE INVENTION

The problems identified above are in large part addressed by a system and method for gathering data to ship a package to a customer via a carrier. The system gathers data associated with a carrier for a shipping transaction, generates a shipping label, and records the shipping transaction via a consumer device such as a desktop computer, to ship the package in response to communication with a consumer or user. The data may be gathered from a first source such as a multi-carrier shipping server if the shipping server is available, and from one or more carriers if the shipping server is unavailable. The system may provide access to data stored in a local or remote location with respect to the consumer device to facilitate the shipping transaction. The data may be stored in a secure location, accessible through an intranet, and the consumer device may facilitate access to the data based upon an access level of the user. The data, for instance, may include consumer data such as product information and customer or destination information for the package in the form of a list like an address book. Thus, gathering consumer data may include interfacing with software such as Microsoft Entourage, Microsoft Outlook, Lotus Notes, etc. Other embodiments of the invention access consumer data from one or more sources. For instance, the user may have access to a global or corporate customer list, a department customer list, a personal customer list, and/or a customer list maintained on a server accessible via the Internet. The system typically provides an interface to access data from one or more of these consumer databases. The system may generate a manifest for a carrier based upon shipping transactions associated with more than one user, having a common pick up location.

### BRIEF DESCRIPTION OF THE DRAWINGS

Other objects and advantages of the invention will become apparent upon reading the following detailed description and upon reference to the accompanying drawings in which, like references may indicate similar elements:

FIG. 1 depicts a system including a wide area network that facilitates communication between a consumer and a shipping server and/or carrier server;

FIG. 2 depicts selected elements of an apparatus to couple with a wide area network to gather data for a shipping transaction to ship a package via the carrier;

FIG. 3 is an exemplary flow chart of a method for gathering data for a shipping transaction to ship a package from a consumer via a carrier; and

FIG. 4 depicts a machine-accessible medium that includes instructions to gather data for a shipping transaction to ship a package from a consumer via a carrier.

### DETAILED DESCRIPTION OF THE PREFERRED EMBODIMENT(S)

The following is a detailed description of example embodiments of the invention depicted in the accompanying drawings. The example embodiments are in such detail as to clearly communicate the invention. However, the amount of detail offered is not intended to limit the anticipated variations of embodiments, but on the contrary, the intention is to cover all modifications, equivalents, and alternatives falling within the spirit and scope of the present invention as defined by the appended claims. The detailed descriptions below are designed to make such embodiments obvious to a person of ordinary skill in the art.

Methods and systems to gather data for a shipping transaction are disclosed. In one embodiment, a system gathers data associated with a carrier for the shipping transaction, generates a shipping label, and records the shipping transaction via a consumer device such as a desktop computer, to ship the package in response to communication with a consumer or user. The data may be gathered from a first source such as a multi-carrier shipping server if the shipping server is available, and from one or more carriers if the shipping server is unavailable. The system preferably provides access to data stored in a local or remote location with respect to the consumer device to facilitate the shipping transaction. The data may be stored in a secure location, accessible through an intranet, and the consumer device may facilitate access to the data based upon an access level of the user. The data, for instance, may include consumer data such as product information and customer or destination information for the package in the form of a list like an address book. Thus, gathering consumer data may include interfacing with a software such as Microsoft Entourage, Microsoft Outlook, Lotus Notes, etc. Other embodiments access consumer data from one or more sources. For instance, the user may have access to a global or corporate customer list, a department customer list, a personal customer list, and/or a customer list maintained on a server accessible via the Internet. Some embodiments provide an interface to access data from one or more of these consumer databases.

After determining the consumer data for the shipping transaction, and determining the consumers preferred carrier and shipping options, embodiments may complete the shipping transaction by generating a shipping label and recording the shipping transaction or user. Some embodiments may print the shipping label along with other shipping labels at the end of the day. Several of these embodiments facilitate generation on an end of the day manifest for a carrier. Other embodiments record the shipping transaction at a location within the intranet associated with the consumer that is accessible by other users that may ship a package by the same carrier, to facilitate generation of an end of the day manifest that includes the shipments by users via a carrier from a common pickup location.

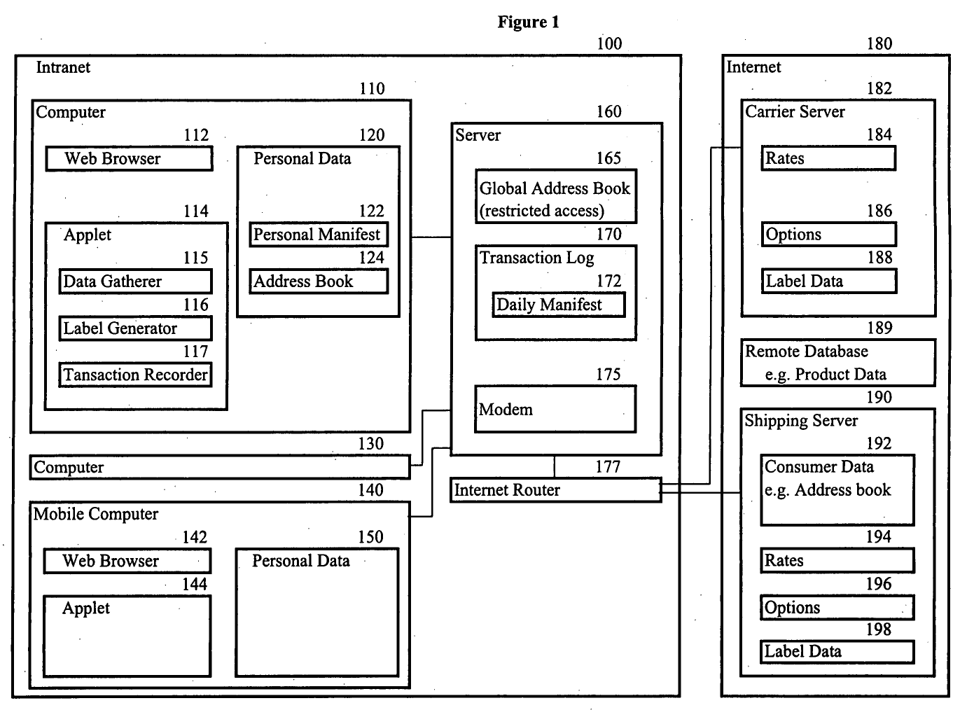

Turning now to the drawings, FIG. 1 depicts an embodiment of a system including a wide area network (WAN), Internet 180, to facilitate communication between a consumer device, computer 110, 130, and 140, and a shipping server 190 and/or carrier server 182 to gather data for a shipping transaction to ship a package via the carrier. The system includes an intranet 100 and Internet 180. Intranet 100 may include part or all of an internal network of a consumer such as a corporate consumer. Intranet 100 includes a computer 110, a computer 130, a mobile computer 140, a server 160, and an Internet router 177. Computer 110 is a stationary computer such as a desktop coupled with server 160 and the user operating computer 110 may ship packages to customers.

Computer 110 includes a web browser 112, an applet 114 coupled with web browser 112, and personal data 120. Web browser 112 provides the user with access to Internet 180 via Internet router 177. For instance, the user associated with computer 110 accesses shipping server 190 via Internet 180 to enhance the consumer's carrier selection capabilities via multi-carrier information comparisons provided by shipping server 190. In response to communication with the user, shipping server 190 downloads applet 114 to computer 110.

Applet 114 may advantageously interact via web browser 112 with sources of data within intranet 100 and available via Internet 180 to facilitate a shipping transaction for the user. Applet 114 includes data gatherer 115, label generator 116, and transaction recorder 117. Data gatherer 115 may interact with the user to collect data, reducing data entry to complete the shipping transaction. For example, the consumer may instruct applet 114 to gather data locally from personal data 120 and remotely from global address book 165 and/or consumer data 192. Personal data 120 may include address book 124 including personal addresses such as addresses for customer contacts that the user stores on a hard drive in computer 110. Global address book 165 may include data available to more than one user, having restricted access based upon an access level associated with a password and/or user name provided by the user. In some embodiments, global address book 165 may be available as read only to users having a direct connection to server 160 rather than a connection via Internet router 177.

Consumer data 192 may include data stored on a shipping server 190 by the user such as an address book. In some embodiments, data gatherer 114 requests passwords and/or user names to access each of the respective databases where applicable, and provides the user with a list of customers, or destinations, for the shipping transaction. In other embodiments, data gatherer 115 may search for a destination based upon data communicated by the user such as a name and/or partial address of a customer.

Similarly, data gatherer 115 may access data locally and/or remotely to describe the package to ship to the destination. Information about packages and/or products that are shipped by the user may be stored in a database within intranet 100 or may be available via Internet 180. For instance, the user wants to drop ship a package from one of several warehouses to a customer. Data gatherer 115 provides a list of products from a local database, and, in response to an indication from the user, applet 114 may establish communication with a remote database 189 associated with one or more warehouses via Internet 180 to provide the user with a list of warehouses having the product in stock.

After the consumer selects the product and destination, data gatherer 115 may acquire rates and shipping options from carrier server 182 and/or shipping server 190. In the present embodiment, shipping server 190 may serve as the primary source of data. When shipping server 190 is unavailable, data gatherer 115 may directly access a carrier's server, such as carrier server 182, to obtain rates 184, options 186, and label data. In some embodiments, however, accessing one or more carrier servers may take more time than accessing multi-carrier data available on shipping server 190.

Applet 114 communicates with shipping server 190 to acquire the rates and options available for a shipping transaction initiated by the user and presents the data to the user. The consumer can then select the shipping rate, option(s), and carrier for the shipping transaction.

Label generator 116 communicates with carrier server 182 and/or shipping server 190 to print a shipping label. Label generator 116 may receive label data, such as label data 188 and 198 to create an electronic image of the shipping label or to transmit to a printer. In some embodiments, label data includes a printer file such as a postscript file is sent to a printer associated with computer 110 to print the shipping label. In other embodiments, the label data includes an electronic file to store and print at a later time. For instance, label generator 116 may communicate an agreement to purchase shipment of a package from the consumer's location to a customers location via a selected shipping method or option, such as by second day air or ground. When shipping server 190 is available to process the transaction, shipping server may respond by transmitting a shipping label to attach to the package. In some embodiments, shipping server 190 provides instructions and/or specifications to applet 114 to facilitate generation of the shipping label by applet 114. In other embodiments, applet 114 may include or locally store instructions and/or specifications to generate a shipping label for one or more carriers and shipping server 190 provides a tracking number, a reference number, or the like.

Transaction recorder 117 may couple with the label generator 116 to record a shipping transaction. In particular, when the consumer associated with computer 110 purchases shipment of a package, transaction recorder 117 stores data describing the shipping transaction. In some embodiments, the data may be stored locally such as in a personal manifest 122 of personal data 120. In many of these embodiments, the consumer may provide or manage a group that provides shipping services for an organization.

In some embodiments, the user associated with computer 110 may include one consumer of more than one consumers in the organization. In such embodiments, transaction recorder 117 advantageously stores data about shipping transactions in a location within intranet 100 accessible to other users like the user associated with mobile computer 140. When applets 114 and 144 record transactions in transaction log 170, a log is maintained that can provide a summary of the transactions of the users associated with computer 110 and mobile computer 140. Further, applets 114 and 144 may associate shipping transaction data in a daily manifest 172 to facilitate generation of a report on the transactions of the day, as well as an end of the day manifest for each carrier involved in a shipping transaction throughout the day. For example, computer 130 may include a computer recently assigned to a consumer of an organization. The consumer may access Internet 180 via server 160 and Internet router 177 to access shipping server 190. Once connected with shipping server 190, the consumer may download an applet from shipping server 190 to facilitate procurement of shipping transactions. The applet may ask a series of questions to customize functionality for the consumer including the types and locations of applications that maintain customer address books, the location for transaction log 170, and the locations remote databases such as remote database 189.

Computer 130 and mobile computer 140 may function like computer 110 to facilitate a shipping transaction. For example, applet 144 may function in a similar manner as applet 114 and mobile computer 140 may include a PDA communicatively coupled with modem 175 via a cellular phone network. The user operating mobile computer 140 may search for and find a shipping rate for shipment for next day delivery by ground for a package and procure transport of the package to a selected customer. When applet 144 attempts to contact shipping server 190 to generate a label, shipping server 190 is unavailable so applet 144 establishes communication with carrier server 180 via web browser 142 and Internet router 177 or another Internet connection available to mobile computer 140. Carrier server 182 may include a server or web site dedicated to a single carrier, the carrier selected by the user associated with mobile computer 140. Applet 144 may transact with an application program interface (API) or the like of carrier server 182 to provide mobile computer 144 with an electronic form of a shipping label or may send the shipping label to a pre-assigned or user-selected printer, fax, and/or email address. In other embodiments, when shipping server 190 is unavailable to provide carrier information such as shipping rates and options, applet 144 communicates with carrier server 182 to generate a label. In several of these embodiments, applet 144 may acquire carrier data from more than one carrier server to provide the consumer with a comparison of rates and shipping options from different carriers.

Server 160 may provide a hub for an intranet network accessible by more than one consumer device to provide central storage for applications, central storage for data, access from remote consumers via modem 175, and access to the Internet via Internet router 177. Server 160 includes global address book 165, transaction log 170, and modem 175.

Internet 180 may provide access to web sites and servers such as carrier server 182, remote database 189, and shipping server 190. Carrier server 182 includes a server for a carrier and provides rates 184, options 186, and label data 188 for the carrier. In some embodiments, carrier server 182 includes an API. In other embodiments, carrier information may be obtained from carrier server 182 via a parsing engine.

Shipping server 190 may maintain updated information about more than one carrier such as rates 194, shipping options 196, and label data 198. In some embodiments, shipping server 190 may organize the information to facilitate comparison by the consumer of rates and options available from different carriers based upon delivery methods and package characteristics. Shipping server 190 may also include consumer data 192. Consumer data 192 includes data storage dedicated to a consumer or a user associated with a consumer.

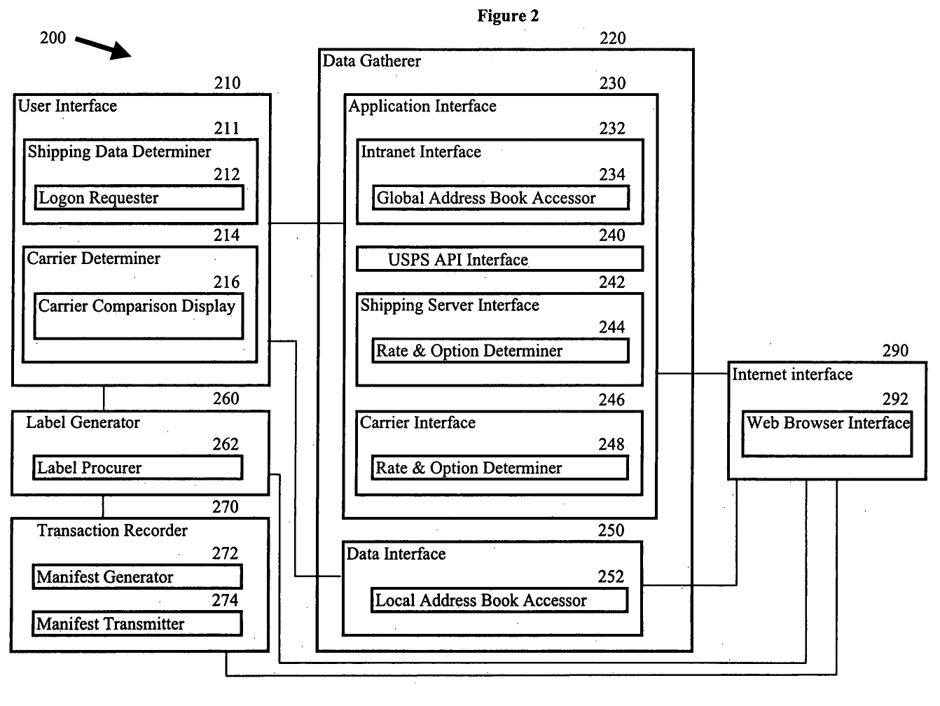

Referring now to FIG. 2, there is shown an embodiment of an apparatus 200 that couples with a wide area network to gather data for a shipping transaction to ship a package via a carrier. Apparatus 200 includes a user interface 210, a data gatherer 220, a label generator 260, a transaction recorder 270, and an Internet interface 290. User interface 210 may communicate with the consumer to select data associated with the shipping transaction. For example, user interface 210 may request that the user indicate the type and location of software or an application that maintains address books of customers, the origin(s) of the packages, and indicate whether other users will procure transportation for packages from the same locations with the same carriers. In some embodiments, an affirmative answer to the latter request leads to configuration of a transaction log associating shipping transactions with a daily manifest to facilitate generation of an end of the day manifest for each carrier. In some embodiments, the end of day manifest may be transmitted to the corresponding carrier electronically via the Internet, facsimile, or the like.

User interface 210 includes a shipping data determiner and a carrier determiner 214. Shipping data determiner 211 may request information from the user to locate data associated with the shipping transaction in local and/or remote databases. For example, shipping data determiner accesses product data to provide a list of products in stock and available to ship that day. The user, or consumer, can select a product from the list and product data such as the weight and dimensions of the packaged product is retrieved from a database.

Shipping data determiner 211 includes user logon requester 212. User logon requester 212 may provide access to confidential information such as customer lists without compromising security measures protecting of the contents of the list. For instance, the user may logon to a global address book located on the intranet. The global address book provides access to users connected directly to the server but prevents access to remote users such as users connected to the server via a modem or via the Internet. After logging on to the global address book, the user may browse or search the address book and select a destination for the package by selecting one or more customers. In some embodiments, user logon requester 212 logs the user out of the global address book and maintains the selected customers' names and addresses to find rates and options for different carriers. In other embodiments, user logon requester 212 may leave the user logged in and maintain offsets to locate the selected customers' names and addresses upon finalizing the shipping transaction.

Carrier determiner 214 may determine rates and shipping options available for a shipping transaction and request that the user select a carrier and shipping option or a shipping rate associated with a carrier and shipping option. Carrier determiner 214 may acquire the carrier information via data gatherer 220 and may include carrier comparison display 216 to present the data to the user. In some embodiments, carrier comparison display 216 displays a comparison of shipping rates and options based on limitations selected by the user such as price range, time period for delivery, carrier, or the like. For example, the user requests all rates for second day delivery for the package. Carrier determiner 214 may forward the request to data gatherer 220 and upon receiving the carrier information, display the rates from lowest to highest price for carriers offering second day delivery for the package.

Data gatherer 220 may gatherer data from local and remote databases to facilitate procurement of a shipping transaction by a user. In particular, data gatherer 220 may reside within a consumer device, such as a computer or PDA, to communicate with a user via user interface 210 to gather data for a shipping transaction to ship a package via the carrier in response to communication with a user. The data is gathered from one or more sources of the data based upon the accessibility of the sources.

Data gatherer 220 includes application interface 230 and data interface 250. Application interface 230 gathers data from databases accessible by interfacing with another application. Application interface 230 includes intranet interface 232, United States Postal Service (USPS) API Interface 240, shipping server interface 242, and carrier interface 246. Intranet interface 232 can be configured to interface with applications to gather data about products, customers, warehouse locations, and the like, to facilitate procurement of a shipping transaction. Intranet interface 232 may include global address book accessor 234 to access customer information stored in programs such as Lotus Notes and Microsoft Outlook.

USPS API interface 240 facilitates access to address information associated with postal customers. For example, a consumer may want to ship a package to a corporation. The consumer knows the city in which the corporation is located but not the physical address so the name of the corporation and city are entered as search criteria. USPS API interface 240 accesses the API provided for the USPS web site and determines one or more corporate addresses that meet the criteria.

Shipping server interface 242 may interface with a shipping server to obtain carrier information and to store and retrieve address book information. Shipping server interface 242 includes rate and option determiner 244. Rate and option determiner 244 accesses rates and shipping options available via one or more carriers to the consumer to ship the package. For example, the shipping server may maintain updated rate tables for multiple carriers along with delivery zone maps, shipping options, pickup and delivery times, etc., by accessing each carrier server. The carrier information is maintained in shipping server to reduce the time involved with retrieving the information from multiple carriers for each shipping transaction. In other embodiments, shipping server may organize the information to facilitate comparison between rates and options of carriers.

When shipping server interface 242 in unable to contact or gather information from the shipping server, application interface 230 may gather carrier information via carrier interface 246. Carrier interface 246 includes rate and option determiner 248. Rate and option 248 is configured to communicate with a carrier server for each carrier to determine rates and options available to the consumer for the shipping transaction. In other embodiments, application interface 230 may access carrier information via carrier interface 246 as a primary source or may access carrier information via both shipping server interface 242 and carrier interface 246 when both are available.

Data interface 250 may access data files such as text files, Excel workbooks, FileMaker Pro database files, and the like without interacting with application software. In the present embodiment, data interface 250 includes local address book accessor 252 to facilitate accessing the data. For instance, a local address book accessor 252 includes a configuration file generated by a consumer to access contact information maintained in a tab delimited text file. In particular, the consumer identifies that the text file is tab delimited and associates the contents of the fields in the text file with data types for a shipping transaction.

Label generator 260 may couple with the data gatherer 220 to generate a carrier-compliant shipping label with the data for the shipping transaction. In particular, data gatherer 220 procures shipping label information from the carrier interface 246 and/or shipping server interface 242 via label procurer 262. For example, FedEx provides an API and data gatherer 220 may be configured to transact with the API to procure a shipping label. FedEx may offer data to print the shipping label in an electronic form to label generator 260. Then, label generator 260 may convert the label into a format(s) indicated by the consumer.

In accordance with the format(s) indicated by the consumer, label generator 260 may create an image of the shipping label in the form of an electronic document such as html or a portable document format (PDF), or the like and communicate with the consumer to determine the format for delivery of the shipping label. In other embodiments, the consumer selects the printer to forward the shipping label to and label generator 260 prints the shipping label immediately or at a specified time. In other embodiments, label generator 260 may generate the shipping label via shipping server interface 242.

Transaction recorder 270 may couple with the label generator 260 to record the shipping transaction. In the present embodiment, transaction recorder 270 stores data identifying the shipping transaction at a location within an intranet, wherein the location is accessible by more than one consumer device or computer. Transaction recorder 270 includes a manifest generator 272 and a manifest transmitter 274. Manifest generator 272 generates an end of the day manifest and manifest transmitter 274 transmits the end of the day manifest to the carrier via the Internet, telephone, facsimile, or the like.

Internet interface 290 provides access to the Internet to gather product data, customer data and carrier data. Internet interface 290 may include web browser interface 292 to facilitate access to sources of data on the Internet via a web browser. In some embodiments, the web browser may include a compiler to execute instructions or commands involved with gathering data locally, via the intranet and/or via the Internet, such as JAVA, HTML, XML, and the like. Further, Internet interface 290 may communicate with a shipping server and/or a carrier server to acquire label data and/or specs to provide an end of the day manifest.

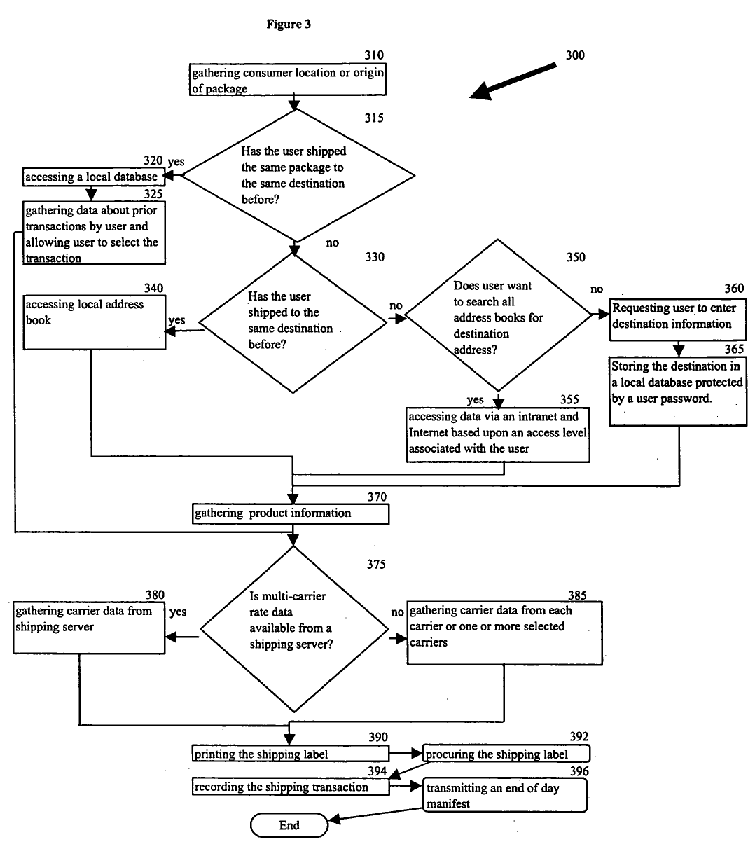

FIG. 3 is an flow chart representing an embodiment of a method 300 for gathering data for a shipping transaction to ship a package from the consumer via a carrier. The depicted embodiment of method 300 begins with gathering consumer information and ends with sending an end of the day manifest to a carrier. Gathering (block 310) consumer location or origin of package determines the origin or location where a package is to be picked up by a carrier. In some embodiments, the origin of the shipments may be entered in a first shipping transaction and automatically be entered thereafter. In other embodiments, the origin of the package may depend upon the warehouse from which the package is shipped so the origin is entered or selected from a list of origins from prior transactions.

After determining the origin of the shipment, the user may asked (block 315) whether the same package or a package with the same dimensions and weight has been delivered to the same customer in a prior transaction. When a prior shipping transaction shipped a similar package to the same destination, accessing (block 320) a local database accesses a database available to the user and gathers data about prior transactions by the user and allows the user to select the transaction (block 325). If the user finds the transaction, the origin, destination, and product data can be retrieved from the prior transaction.

On the other hand, when there is no prior transaction to the same destination with the same or similar product, the address for the destination may reside in an address book. If the user has shipped to the destination before (block 330) then the address may be located in a local address book for the user. Accessing (block 340) a local address book may reduce the data entry involved in specifying a destination for the shipping transaction. Otherwise, the user is asked whether available address books should be searched based upon search criteria supplied by the user or whether the user wants to enter the destination information (block 350). In some embodiments, searching available address books may involve searching an on-line address database such as an address database provided by Verizon, Southwestern Bell, or the like.

When the user decides to search available address books, the user may enter criteria such as a partial customer name, address, or the like. The search may involve accessing protected or sensitive data such as a global address book located on a company's intranet. In some embodiments, the user provides login information to access the protected or sensitive data.

On the other hand, when the user enters (block 360) the destination or customer data, the data can be stored (block 365) in a database. In some embodiments, the database is stored locally. In other embodiments, the database is stored in a location accessible by other consumers via the intranet and the database is encrypted to provide access with a password or public key, to prevent general availability of the customer information.

After acquiring data describing the destination for the package, product information is gathered (block 370) to obtain information about the package to be shipped. Gathering this product information includes requesting information about the product from the user, and in some embodiments, providing a list of products from which the user can choose the product to ship. For example, a consumer that ships a variety of products in a regular course of business maintains information about the size and weight of the products when packed for shipment in a database, or the like, available through the intranet to one or more consumers of the company. The product data may also associate the product with a time for preparing the product for pickup by a carrier. Embodiments access the database, prompting the consumer to logon to the intranet and/or database where applicable. In some embodiments, the consumer selects the product from a list and the size and weight information about the packaged product are retrieved for the shipping transaction. In other embodiments, the information about the package may be determined before determining the destination.

Upon receiving information about the origin, destination, and package, a source for carrier information is determined. In some embodiments, the availability of a multi-carrier source of the carrier rates and options is determined first (block 375). When a multi-carrier source is available, gathering carrier data (block 380) retrieves shipping rates and options for more than one carrier from the same source, such as a shipping server that maintains updated information about the carrier. Otherwise, carrier information is gathered (block 385) from each carrier or one or more selected carriers.

Printing the shipping label (block 390) may including communicating with a shipping server or a carrier server after the carrier, rate, and shipping option are selected, to print a carrier-compliant shipping label to attach to the package. Printing the shipping label (block 390) includes procuring the shipping label (block 392) from a carrier. For example, the consumer enters information to ship a package from a location to a customer and finalizes the transaction by requesting the shipping label be printed at the printer in the product storage room. In response, software executing on the consumers computer contacts the selected carrier or the shipping server, provides information to identify the shipping transaction and requests a shipping label be printed at the printer in the storage room via the consumers computer. When the carrier server and shipping server are unavailable via Internet, the carrier or shipping server may be contacted via modem. In some embodiments, label data such as a reference number and a tracking number are received in response to requesting the shipping label be printed. In other embodiments, an electronic file describing the shipping label in the form of an image or the like may be received.

Recording the shipping transaction (block 394) may store a record of the shipping transaction on the consumer's computer or within an intranet coupled with the consumer's computer. In some embodiments, the transaction may be stored on the shipping server or a carrier server. In other embodiments, the transaction may be recorded by transmitting an end of the day manifest to the selected carrier (block 396).

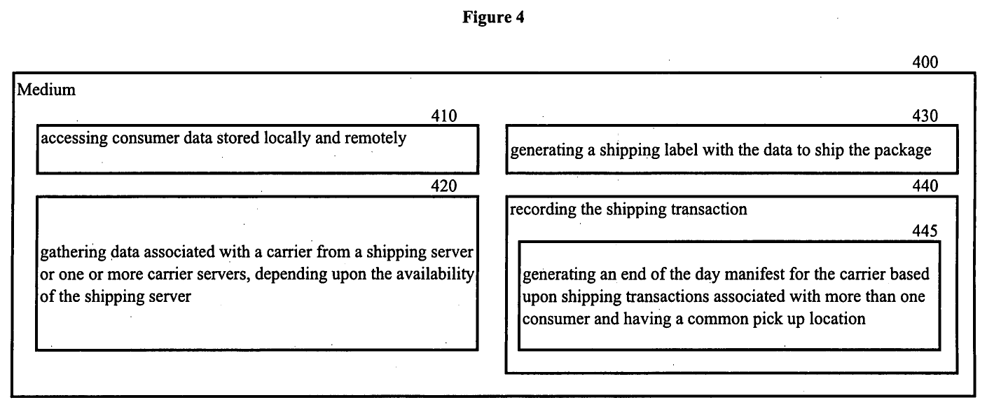

Referring now to FIG. 4, a machine-accessible medium embodiment of the present invention is shown. A machine-accessible medium includes any mechanism that provides (i.e. stores and or transmits) information in a form readable by a machine (e.g., a computer), that when executed by the machine, can perform the functions described herein. For example, a machine-accessible medium may include read only memory (ROM); random access memory (RAM); magnetic disk storage media; optical storage media; flash memory devices; electrical, optical, acoustical or other form of propagated signals (e.g. carrier waves, infrared signals, digital signals, etc.); etc. Some embodiments of the present invention can include more than one machine-accessible medium depending on the design of the machine.

The medium 400 may include instructions for accessing consumer data stored locally and remotely (block 410); gathering data associated with a carrier from a shipping server or one or more carrier servers, depending upon the availability of the shipping server (block 420); generating a shipping label with the data to ship the package (block 430); and recording the shipping transaction (block 440). Accessing consumer data stored locally and remotely (block 410) may include instructions for setting up access to multiple databases, wherein the databases are located on the consumer's computer and on other computers or servers accessible via intranet, Internet, and/or modem. In some embodiments, setting up access to multiple databases involves requesting the consumer to identify locations of the databases or applications associated with the databases. In some embodiments, accessing the databases involves requesting the consumer to supply logon information.

Instructions for gathering data associated with a carrier from a shipping server or one or more carrier servers, depending upon the availability of the shipping server (block 420) includes communicating with the shipping server as a default source and contacting the selected carrier server as a backup source. In other embodiments, one or more shipping servers-may also include backup sources.

Instructions for generating a shipping label with the data to ship the package (block 430) may generate a carrier-compliant shipping label with the data for the shipping transaction. Generating a shipping label with the data to ship the package (block 430) receives shipping label information from the carrier server and/or shipping server to print the shipping label. For instance, UPS may provide an API interface and data gatherer 220 may be configured to transact with the API of UPS to procure a shipping label. UPS may offer data to print the shipping label in an electronic form that may be converted into a format(s) indicated by the consumer. In some embodiments, the consumer may indicate an image format for the shipping label such as tagged image file format (TIFF) or joint photographic experts group (JPEG) format, or the like. In other embodiments, the consumer selects a printer or facsimile machine and the shipping label is transmitted immediately or at a specified time to the selected printer or facsimile machine.

Instructions for recording the shipping transaction 440 may generate a log entry describing the shipping transaction. Recording the shipping transaction 440 may include generating an end of the day manifest for the carrier based upon shipping transactions associated with more than one consumer and having a common pick up location 445. In such embodiments, the log entry may be stored in a log accessible to the more than one consumer. The entries common to one carrier are selected to generate an end of the day manifest for the carrier and transmitted to the carrier via the Internet, telephone, facsimile, or the like.

It will be apparent to those skilled in the art having the benefit of this disclosure that the present invention contemplates methods and systems to gather data for a shipping transaction, process the transaction by accessing one or more databases located locally and/or remotely, and communicate with a shipping server and/or carrier server depending upon availability of the servers, to print a shipping label to ship a package via the carrier. It is understood that the form of the invention shown and described in the detailed description and the drawings are to be taken merely as presently preferred examples. It is intended that the following claims be interpreted broadly to embrace all the variations of the preferred embodiments disclosed.

1. A method to enhance a shipping transaction, comprising:
gathering data associated with a shipping transaction, in response to communication with a consumer, via a consumer device, from a source of more than one sources of the data based upon accessibility of the source;
generating a shipping label for the shipping transaction based upon the data; and
recording the shipping transaction.

2. The method of claim 1, wherein gathering data comprises accessing the data based upon an access level associated with the consumer, wherein the data is stored in an intranet coupled with the consumer device.

3. The method of claim 2, wherein accessing the data comprises accessing an address book to determine a destination associated with the shipping transaction.

4. The method of claim 1, wherein gathering data comprises accessing a remote database.

5. The method of claim 1, wherein gathering data comprises determining a rate associated with the shipping transaction via an application program interface associated with a carrier server.

6. The method of claim 1, wherein gathering data comprises determining a rate associated with the shipping transaction for more than one carrier from the source.

7. The method of claim 1, wherein generating a shipping label comprises communicating with a carrier to print a shipping label.

8. The method of claim 1, wherein recording the shipping transaction comprises transmitting a manifest to a carrier.

9. The method of claim 1, wherein recording the shipping transaction comprises storing the data at a location within an intranet via the consumer device to generate a manifest associated with shipping transactions recorded by more than one consumer device.

10. An apparatus, comprising:
a data gatherer residing in a consumer device to communicate with a consumer to gather data for a shipping transaction from a source of more than one sources of the data based upon accessibility of the source;
a label generator coupled with the data gatherer to generate a shipping label based upon the data; and
a transaction recorder coupled with the label generator to record the shipping transaction.

11. The apparatus of claim 10, wherein the data gatherer comprises a user interface to communicate with the consumer to select data associated with the shipping transaction.

12. The apparatus of claim 10, wherein the data gatherer comprises an application interface to access protected consumer data via an access level associated with the consumer.

13. The apparatus of claim 10, wherein the data gatherer couples with an Internet interface to gather data from a remote location.

14. The apparatus of claim 10, wherein the data gatherer comprises a data interface to access a local database.

15. The apparatus of claim 10, wherein the data gatherer comprises a rate determiner to determine a rate associated with the shipping transaction via an application program interface associated with a carrier server.

16. The apparatus of claim 10, wherein the data gatherer comprises a rate determiner to determine a rate associated with the shipping transaction for more than one carrier from the source.

17. The apparatus of claim 10, wherein the label generator comprises a label procurer to procure a shipping label.

18. The apparatus of claim 10, wherein the transaction recorder comprises a transaction logger to store the data at a location within an intranet via the consumer device to generate a manifest associated with shipping transactions recorded by more than one consumer device.

19. The apparatus of claim 10, wherein the transaction recorder comprises a manifest generator to generate an end of the day manifest to transmit to the carrier.

20. A system to enhance shipping transactions, comprising:
a shipping server to store data, wherein the data comprises rates associated with a shipping transaction for more than one carrier; and
instructions to install on a consumer device, to cause the consumer device to perform operations, comprising
gathering data associated with a shipping transaction, in response to communication with a consumer, via a consumer device, from the shipping server when the shipping server is accessible and from a carrier server when the shipping server is inaccessible;
generating a shipping label for the shipping transaction based upon the data; and
recording the shipping transaction.

21. The system of claim 20, wherein generating a shipping label is configured to communicate with an application program interface of the carrier to print the shipping label.

22. The system of claim 20, wherein generating a shipping label is configured to communicate with the shipping server to print the shipping label.

23. The system of claim 20, wherein recording the shipping transaction comprises storing the data at a location within an intranet coupled with the consumer device, wherein the location is accessible by more than one consumer device.

24. A machine-readable medium containing instructions, which when executed by a machine, cause said machine to perform operations, comprising:
gathering data associated with a shipping transaction, in response to communication with a consumer, via the machine, from a source of more than one sources of the data based upon accessibility of the source;
generating a shipping label for the shipping transaction based upon the data; and
recording the shipping transaction.

25. The machine-accessible medium of claim 24, wherein gathering data comprises accessing consumer data stored in an intranet coupled with the machine based upon an access level associated with the consumer.

26. The machine-accessible medium of claim 24, wherein gathering data associated comprises gathering data from an application interface program associated with the carrier when a primary source of the data is inaccessible.

27. The machine-accessible medium of claim 24, wherein gathering data comprises accessing a rate table for the carrier via a server, wherein the server is to provide a rate table for more than one carrier.

28. The machine-accessible medium of claim 24, wherein recording the shipping transaction comprises storing data associated with the shipping transaction at a location within an intranet of the consumer, wherein the location is accessible by more than one machine coupled with the intranet.
